(19) United States
(12) Patent Application Publication
(10) Pub. No.: US 2006/0247457 A1
(43) Pub. Date: Nov. 2, 2006

(54) Method for the synthesis of methyl-tri-oxo-rhenium

(76) Inventors: Stefano Turchetta, Roma (IT); Massardo Pietro, Roma (IT); Tuozzi Angela, Roma (IT)

Correspondence Address: NIXON & VANDERHYE, PC, 901 NORTH GLEBE ROAD, 11TH FLOOR, ARLINGTON, VA, 22203, US

(21) Appl. No.: 10/545,912

(22) PCT Filed: Feb. 16, 2004
(86) PCT No.: PCT/IT04/00060

§ 371 Date: Oct. 19, 2005

(30) Foreign Application Priority Data
Feb. 27, 2003 (IT) MI2003A000352

(51) Int. Cl. C07F 15/00

(52) U.S. Cl. 556/136

(57) ABSTRACT

A method for the synthesis of methyltrioxorhenium is described, wherein 0.5-1.5 moles of dirhenium heptaoxide are reacted with 1-3 moles of tetramethyl tin in the presence of 1-3 moles of chlorotrimethyl silane. The synthesis is carried out in the dark for approximately 24 hours in a polar aprotic organic solvent, preferably in acetonitrile.

### FIELD OF THE INVENTION

The subject of the invention is a method for the synthesis of methyltrioxorhenium, characterized in that the method is implemented by reaction between dirhenium heptaoxide, chlorotrimethyl silane, and tetramethyl tin and the crude product obtained upon completion of the reaction is purified by filtration on silica gel.

### STATE OF THE ART

Methyltrioxorhenium is an organometallic rhenium compound which has the structural formula:

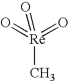

It is used as a catalyst in a series of reactions such as: metathesis of alkenes (Herrmann W. A. et al. U.S. Pat. No. 5,342,985 (1994), expoxidation of alkenes with H₂O₂ (Herrmann W. A. et al., Agnew., Chem. Int. Ed. Engl., 1991, 30, 1638), Bayer-Williger oxidation of ketones. (Herrmann W. A. et al., J. Mol. Catal., 1994, 94, 213), oxidation of sulphides to sulphoxides (Herrmann W. A. et al., Inorg. Chem., 1993, 32, 4517; Yamazaki S., Bull. Chem. Soc. Jpn., 69, 2955 (1996); Vassell K. A. et al., Inorg. Chem., 33, 5491 (1994); Adam W. et al., Tetrahedron 50 (46), 13121 (1994)), oxidation of sulphoxides to sulphones (Ladahti D. W. et al., Inorg. Chem.; 2000, 39, 2164), and oxidation of compounds containing phosphorus or, nitrogen (Zhu Z. et al., J. Org. Chem., 1995, 60, 1326; Murray R. W. et al.; Tetrahedron Lett., 1996, 37, 805; Goti A. et al., Tetrahedron Lett., 1996, 37, 6025).

In spite of the increasing number of applications and the increasing quantity of publications relating, to the use of methyltrioxorhenium in organic synthesis, only a few methods for its synthesis are available in the literature.

It was synthesized for the first time as a by-product in 1978 (Beattie I. R., Jones F. J., Inorg. Chem. 1978, 18, 2318.)

It was prepared in 1988 by adaptation of a method for the preparation of a catalyst for the, metathesis of olefins (Herrmann W. A., Kuchler J. G. et al., Agnew. Chem. Int. Ed. Engl., 1988, 27, 394) by the following reaction:
Re₂O₇+Me₄Sn→MeReO₃+(CH₃)₃SnOReO₃

In this synthesis, 50% of the starting dirhenium heptaoxide is used up to produce a reaction by-product, trimethylsilyl perrhenate.

U.S. Pat. No. 6,180,807 describes the synthesis of methyltrioxorhenium in accordance with the following scheme:
NaReO₄+2Me₃SiCl+Me₄Sn→MeReO₃+NaCl+Me₃SnCl+Me₃Si—O—SiO₃

In this case, the yield expected from the examples described is 70%. However, the method provides for a final purification of the crude product by sublimation which is a technique that is difficult to use for large-scale preparations. Moreover, the method described leads to products which are very impure owing to the presence of the organic-tin by-products used in the synthesis, which are highly toxic. Finally, the yield of sublimed product obtained does not exceed 50%. U.S. Pat. No. 5,342,985 describes the synthesis of methyltrioxorhenium in accordance with the following scheme:
Re₂O₇+Me₂Zn→2MeReO₃+ZnO

For this synthesis, a yield of 78% is reported, but repetition of the method described does not enable yields greater than 20% to be obtained. Moreover, in this case again, a final purification by sublimation is provided for, with the same disadvantages as described above.

There is therefore still a need to identify a method for the synthesis of methyltrioxorhenium, which is, reproducible and applicable on a large scale and which enables the product to be obtained at costs such as to render its use as an industrial synthesis catalyst advantageous.

### SUMMARY OF THE INVENTION

In experiments directed towards finding an economically advantageous method for the synthesis of methyltrioxorhenium, it has surprisingly been found that methyltrioxorhenium can be synthesized from dirhenium heptaoxide by reaction with chlorotrimethyl silane and tetramethyl tin, producing crude reaction products which are cleaner and less difficult to process in comparison with those that can be obtained from sodium perrhenate, chlorotrimethyl silane, and tetramethyl tin (U.S. Pat. No. 6,180,807). This technique also avoids the need to filter NaCl from the reaction mixture (as is required in U.S. Pat. No. 6,180,807), which contains highly toxic products such as the compounds tetramethyl tin and trimethyl tin chloride.

In the course of the above-mentioned experiments, it has also surprisingly been found that the crude products obtained both from synthesis starting with dirhenium heptaoxide, chlorotrimethyl silane, and tetramethyl tin and from the syntheses reported in thee literature can advantageously be purified by filtration on panels of silica gel and subsequent pulping from aliphatic hydrocarbons, thus avoiding sublimation. Moreover, the product obtained by this technique has a high degree of purity.

The subject of the present invention is therefore a novel method for the synthesis of methyltrioxorhenium from dirhenium heptaoxide by reaction of chlorotrimethyl silane and tetramethyl tin, and a method for the purification of the crude methyltrioxorhenium thus obtained.

### DETAILED DESCRIPTION OF THE INVENTION

The reaction of dirhenium, heptaoxide with chlorotrimethyl silane and tetramethyl tin which is the subject of the present invention can be described by the following stoichiometric reaction:
Re₂O₇+2ClSiMe₃+2Me₄Sn→2MeReO₃+Me₃SiOSiMe₃+2ClSnMe₃

The synthesis of methyltrioxorhenium by reaction of dirhenium heptaoxide with tetramethyl tin in the absence of chlorotrimethyl silane was described in 1988; however, half of the initial rhenium compound is lost in this preparation owing to the formation of trimethylsilyl perrhenate. The, use of chlorotrimethyl silane enables all of the initial dirhenium heptaoxide to be transformed into methyltrioxorhenium.

The reaction is carried out in a polar aprotic organic solvent such as, for example, acetonitrile. Dirhenium heptaoxide is added to the solvent and dissolved. Chloromethyl silane, and subsequently tetramethyl tin, are then added to the solution. The mixture obtained is stirred at ambient temperature for about 24 hours in the dark and the solvent is then removed by distillation under vacuum and an apolar organic solvent, preferably a chlorinated solvent, even more preferably dichloromethane, is added to the residue. The solution is then passed through a quantity of silica gel of approximately the same weight as the dirhenium heptaoxide used. The resulting solution is evaporated to residue and the residue is taken up with an aliphatic hydrocarbon such as pentane, hexane, heptane, or cyclohexane, to give a suspension of colourless methyltrioxorhenium crystals. The crystalline product can then be filtered and washed with the same aliphatic hydrocarbon which was used for the resuspension of the residue and dried thoroughly at 25-30° C. for 24 hours. Methyltrioxorhenium with an ¹H-NMR purity greater than 99% is thus obtained.

The method of purification by filtration on silica gel is applicable to crude reaction products resulting both from the reaction between perrhenates chlorotrimethyl silane and tetramethyl tin described in U.S. Pat. No. 6,180,807, and from the reaction between rhenium heptaoxide and dimethyl zinc described in U.S. Pat. No. 5,342,985.

The following examples are intended to explain the invention further and do not in any way constitute a limitation thereof.

### EXAMPLE 1

### Synthesis of Methyltrioxorhenium from Dirhenium Heptaoxide, Chlorotrimethyl Silane, and Tetramethyl Tin

2500 of anhydrous acetonitrile (K.F.<0.1%) and 500.0 g of dirhenium heptaoxide were introduced, in order, into a 5 l reactor provided with a loading funnel, mechanical stirring, and a thermometer, and under a light stream of nitrogen. 258 g of chlorotrimethyl silane was introduced into the loading funnel and was added to the suspension at a temperature of 25° C. over a period of 15′. No exothermy was observed but the colour of the suspension progressively became yellow and the solid product which was originally present tended to dissolve. 387.6 g of tetramethyl tin was then introduced into the loading funnel and the product was added over about 30′; slight exothermy (2° C.) was observed and the reaction mixture progressively became dark brown, but remained clear. The mixture was kept at 25° C. in the dark and with stirring for 24 hours. The mixture was then concentrated under vacuum (about 40 mmHg) to give a residue, without exceeding an internal temperature of 45° C. About 1200 g of crude methyltrioxorhenium was obtained.

### EXAMPLE 2

### Purification of the Crude Methyltrioxorhenium of Example 1

1700 ml of dichloromethane were added to the crude methyltrioxorhenium obtained in Example 1. The solution possibly contained traces of solid and was loaded into a column of silica gel prepared from 500 g of silica gel and 1000 ml of dichloromethane.

The column was eluted with a further 2000 ml of dichloromethane. The organic solution obtained was evaporated thoroughly again until about 3000. ml of solvent was collected; evaporation under vacuum (40 mmHg) was then performed to give a residue, without exceeding an internal temperature of 45° C. The residue obtained was taken up with 250.0 ml of cyclohexane. A suspension of white crystalline product was obtained; the product was filtered and washed with 500 ml of cyclohexane. The product was left under vacuum for 15-20′ and dried thoroughly at 20-25° C. for 24 hours. 399.9 g of product was obtained with a yield of 77.8%. ¹H-NMR analysis showed a purity of the product of >99%.

### EXAMPLE 3 (COMPARATIVE)

### Synthesis of Methyltrioxorhenium from Sodium Perrhenate, Chlorotrimethyl Silane, and Tetramethyl Tin

5.0. g of sodium perthenate and 50 ml of anhydrous acetonitrile (K.F. <0.1%) were introduced into a 100 ml flask provided with a loading funnel and mechanical stirring and under a light-stream of nitrogen.

4.46 g of chlorotrimethyl: silane was introduced into the loading flask and was added to the suspension at a temperature of 25° C. over a period of 5′. The colour of the suspension progressively became yellow and the salt which was originally present tended to dissolve, precipitating in its place a less heavy and white solid constituted by NaCl.

The mixture was kept at 25° C. for 2 hours and 40′ with stirring, protected from light. 3.6 g of tetramethyl tin was introduced into the loading funnel. The product was added over about 10′ and slight exothermy (2° C.) was observed whilst the reaction mixture progressively became dark brown with solid still present. The mixture was kept at 25° C. in the dark and with stirring for 20 hours and upon completion, the resulting solid was filtered and the solution obtained evaporated to residue. 12 g of crude methyltrioxorhenium was obtained.

### EXAMPLE 4 (COMPARATIVE)

### Purification of the Crude Methyltrioxorhenium of Example 3

50 ml of dichloromethane was added to the crude methyltrioxorhenium obtained in Example 3. The solution was loaded into a column of silica gel prepared from 10 g of silica gel and 50 ml of dichloromethane.

The column was eluted with a further 50 ml of dichloromethane. The organic solution obtained was evaporated thoroughly to residue again. The residue was taken up with 50 ml of pentane to give a suspension of white crystalline product which was filtered and washed with 10 ml of pentane.

The crystalline-solid obtained weighed 3.10 g for a 68.% yield of methyltrioxorhenium. ¹H-NMR analysis showed that the product had a purity of >99%.

### EXAMPLE 5 (COMPARATIVE)

### Synthesis, of Methyltrioxorhenium from Dirhenium Heptaoxide and Dimethyl Zinc

20.7 ml of a solution of dimethyl zinc in tetrahydrofuran was added to a solution of 10 g of rhenium heptaoxide in 25.0 ml of tetrahydrofuran and the mixture was stirred at 25° C., for two hours, in the course of which a white precipitate was formed.

The precipitate was filtered and the resulting solution was evaporated at 35-40° C. under a slight vacuum (200-300 mmHg). 10 g of crude methyltrioxorhenium was obtained.

### EXAMPLE 6 (COMPARATIVE)

### Purification of the Crude Methyltrioxorhenium of Example 5

The crude methyltrioxorhenium obtained in Example 5 was purified using the same methods as described in Example 4. After filtration from pentane and drying, 1.75 g of methyltrioxorhenium was obtained (yield 17%).

1. Method for the synthesis of methyltrioxorhenium, characterized in that dirhenium heptaoxide is reacted with tetramethyl tin in the presence of chlorotrimethyl silane.

2. Method according to claim 1, characterized in that 0.5-1.5 moles of dirhenium heptaoxide are reacted with 1-3 moles of tetramethyl tin in the presence of 1-3 moles of chlorotrimethyl silane.

3. Method according to claim 2, characterized in that approximately 1 mole of dirhenium heptaoxide is reacted with approximately 2 moles of tetramethyl tin in the presence of approximately 2 moles of chlorotrimethyl silane.

4. Method according to claim 1, characterized in that it is performed in a polar aprotic organic solvent.

5. Method according to claim 1, characterized in that it is performed in acetonitrile.

6. Method according to claim 1, characterized in that the dirhenium heptaoxide is initially added to the solvent and dissolved therein, the chlorotrimethyl silane, and subsequently the tetramethyl tin, then being added to the solution thus obtained.

7. Method according to claim 1, characterized in that the mixture containing dirhenium heptaoxide, tetramethyl tin, and chlorotrimethyl silane is stirred in the dark at ambient temperature for 18-36 hours, preferably for about 24 hours.

8. Method according to claim 4, characterized in that the methyltrioxorhenium thus obtained is purified by elution on silica gel.

9. Method according claim 4, characterized in that, upon completion of the synthesis, the solvent is removed by distillation and the residue thus obtained is taken up with an apolar organic solvent; the mixture thus obtained is then passed through a quantity of silica gel of approximately the same weight as the dirhenium heptaoxide used.

10. Method according to claim 9, characterized in that the resulting solution is evaporated to residue and the residue is taken up with an aliphatic hydrocarbon, to give a crystalline suspension of methyltrioxorhenium.

11. Method according to claim 9, characterized in that the apolar organic solvent is a chlorinated solvent, preferably methylene chloride.

12. Method according to claim 10, characterized in that the aliphatic hydrocarbon is selected from pentane, hexane, heptane, and/or cyclohexane.
